(19) United States
(12) Patent Application Publication
(10) Pub. No.: US 2013/0275083 A1
(43) Pub. Date: Oct. 17, 2013

(54) APPARATUS AND METHOD FOR MEASURING THICKNESS OF PRINTED CIRCUIT BOARD

(71) Applicant: Jin JEONG, Seoul (KR)

(72) Inventor: Jin JEONG, Seoul (KR)

(73) Assignee: Avago Technologies Wireless IP (Singapore) Pte. Ltd., Singapore (SG)

(21) Appl. No.: 13/447,490

(22) Filed: Apr. 16, 2012

(51) Int. Cl. G01N 27/02; G01B 17/02; G06F 15/00

(52) U.S. Cl. 702/172; 702/170

(57) ABSTRACT

An apparatus for measuring a thickness of at least one insulating layer of a printed circuit board (PCB), the at least one insulating layer having a transmission line located thereon. The apparatus includes an impedance measurement unit configured to input a plurality of input signals to the transmission line, each of the input signals having a respective frequency, to receive output signals from the transmission line, and to determine impedance values of the at least one insulating layer based on the input signals and the output signals; and a thickness calculation unit configured to calculate a thickness of the at least one insulating layer based on the impedance values.

### BACKGROUND

The inventive concepts described herein are generally related to an apparatus and method for measuring a thickness of a printed circuit board (PCB) and, in particular, to an apparatus and method for electrically measuring a thickness of at least one insulating layer of a PCB.

Printed circuit boards (PCBs) typically accommodate electronic components thereon. The electronic components may be electrically interconnected by conductive lines. Electromagnetic interference and impedance matching of the electronic components are generally influenced by the thickness of an insulating layer(s) of the PCB. Therefore, it may be necessary or desirable to measure a thickness of the insulating layer(s) of a PCB prior to placing electronic components thereon.

However, conventional techniques have been primarily designed to measure only the overall thickness of a PCB, not to directly measure the thickness of one or more insulating layers of the PCB. Moreover, in a multi-layer PCB including a plurality of insulating layers, information on the thicknesses of certain of the insulating layers may be necessary to help determine whether the PCB meets desired quality requirements.

Accordingly, there is needed a technique capable of measuring thicknesses of at least some of the insulating layers of a PCB.

### SUMMARY

In a representative embodiment, there is provided an apparatus for measuring a thickness of at least one insulating layer of a printed circuit board (PCB), the at least one insulating layer having a transmission line located thereon. The apparatus includes an impedance measurement unit configured to input a plurality of input signals to the transmission line, to receive output signals from the transmission line, and to determine impedance values of the at least one insulating layer based on the input signals and the output signals, wherein each of the input signals has a respective frequency; and a thickness calculation unit configured to calculate a thickness of the at least one insulating layer based on the impedance values.

The impedance measurement unit may compare magnitudes and phases of the input signals with those of the output signals to calculate S-parameter values of the at least one insulating layer. Subsequently, the impedance measurement unit may convert the calculated S-parameter values into respective impedance values.

The thickness calculation unit may select from among the impedance values an impedance value having a smallest imaginary part, after the impedance values are determined by the impedance measurement unit. Subsequently, the thickness calculation unit may calculate the thickness of the at least one insulating layer based on the selected impedance value. The thickness may be calculated in accordance with the following equation:

$$\begin{matrix}h = \frac{W ( {e}^{2 A} - 2 )}{8 {e}^{A}} ( if W \text{/} h < 2 ) \\ = \frac{π W}{2 [ \begin{matrix}B - 1 - In ( 2 B - 1 ) + \frac{{ɛ}_{r} - 1}{2 {ɛ}_{r}} \\ \{ In ( B - 1 ) + 0.39 - \frac{0.61}{{ɛ}_{r}} \}\end{matrix} ]} ( if W \text{/} h < 2 ) \\ A = \frac{{Z}_{0}}{60} \sqrt{\frac{{ɛ}_{r} + 1}{2}} + \frac{{ɛ}_{r} - 1}{{ɛ}_{r} + 1} ( 0.23 + \frac{0.11}{{ɛ}_{r}} ) \\ B = \frac{377 π}{2 {Z}_{0} \sqrt{{ɛ}_{r}}}\end{matrix}$$

where W is a width of the transmission line, Z₀ is a selected impedance value, and ∈ᵣ is a dielectric constant of said at least one insulating layer.

The apparatus may further include a thickness comparison unit for determining whether the calculated thickness falls within a predetermined range to check whether the PCB meets desired quality criteria.

In a further representative embodiment, there is provided a method of measuring a thickness of at least one insulating layer of a printed circuit board (PCB), the at least one insulating layer having a transmission line located thereon. The method includes measuring impedance values by inputting a plurality of input signals to the transmission line, by receiving output signals from the transmission line, and by determining impedance values based on the input signals and the output signals, wherein each of the input signals has a respective frequency; and calculating a thickness of the at least one insulating layer based on the measured impedance values.

### BRIEF DESCRIPTION OF THE DRAWINGS

The example embodiments are best understood from the following detailed description when read with the accompanying drawings. It is emphasized that the various features are not necessarily drawn to scale. In fact, the dimensions may be arbitrarily increased or decreased for clarity of discussion. Wherever applicable and practical, like reference numerals refer to like elements.

FIG. 1 is a schematic block diagram illustrating an apparatus for measuring a thickness of at least one insulating layer of a printed circuit board (PCB), according to a representative embodiment.

FIGS. 2A and 2B are respective schematic and cross-sectional views of a PCB having a test region, according to a representative embodiment.

FIGS. 3A to 3C illustrate Smith charts representing exemplary results of impedance values for at least one insulating layer, according to a representative embodiment.

FIG. 4 illustrates exemplary results of impedance values for at least one insulating layer, according to a representative embodiment.

FIG. 5 illustrates exemplary results of thicknesses for at least one insulating layer, according to a representative embodiment.

FIG. 6 illustrates a flow diagram of a process for measuring a thickness of at least one insulating layer of a PCB, according to another representative embodiment.

### DETAILED DESCRIPTION

In the following detailed description, for purposes of explanation and not limitation, representative embodiments disclosing specific details are set forth in order to provide a thorough understanding of the present teachings. However, it will be apparent to one having ordinary skill in the art having had the benefit of the present disclosure that other embodiments according to the present teachings that depart from the specific details disclosed herein remain within the scope of the appended claims. Moreover, descriptions of well-known apparatuses and methods may be omitted so as to not obscure the description of the representative embodiments. Such methods and apparatuses are clearly within the scope of the present teachings.

Generally, it is understood that the drawings and the various elements depicted therein are not drawn to scale. Further, relative terms, such as “above,” “below,” “top,” “bottom,” “upper,” “lower,” “left,” “right,” “vertical” and “horizontal,” are used to describe the various elements' relationships to one another, as illustrated in the accompanying drawings. It is understood that these relative terms are intended to encompass different orientations of the device and/or elements in addition to the orientation depicted in the drawings. For example, if the device were inverted with respect to the view in the drawings, an element described as “above” another element, for example, would now be “below” that element. Likewise, if the device were rotated 90 degrees with respect to the view in the drawings, an element described as “vertical,” for example, would now be “horizontal.

Further, as used in the specification and appended claims, the terms “a”, “an” and “the” include both singular and plural referents, unless the context clearly dictates otherwise. Thus, for example, “a device” includes one device and plural devices.

As used in the specification and appended claims, and in addition to their ordinary meanings, the terms “substantial” or “substantially” mean to within acceptable limits or degree. For example, “substantially cancelled” means that one skilled in the art would consider the cancellation to be acceptable.

As used in the specification and the appended claims and in addition to its ordinary meaning, the term “approximately” means to within an acceptable limit or amount to one having ordinary skill in the art. For example, “approximately the same” means that one of ordinary skill in the art would consider the items being compared to be the same.

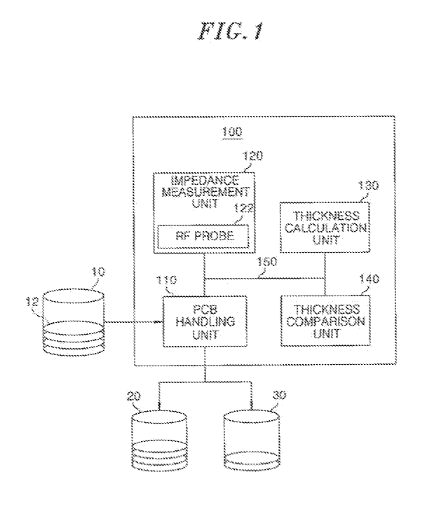

FIG. 1 is a schematic block diagram illustrating an apparatus for measuring a thickness of at least one insulating layer of a printed circuit board (PCB), according to a representative embodiment.

Apparatus 100 as shown in FIG. 1 may measure a thickness of at least one insulating layer of a PCB. Furthermore, apparatus 100 may automatically and repeatedly measure the thickness of a respective insulating layer for multiple PCBs. For example, apparatus 100 may successively measure the thickness of a respective insulating layer of each of the PCBs stacked in an incoming cassette 10, determine whether each of the PCBs meets desired quality requirements based on the measured thicknesses, and place each of the PCBs into outgoing cassettes 20 and 30 depending on the determination.

Referring to FIG. 1, the apparatus 100 includes a PCB handling unit 110, an impedance measurement unit 120, a thickness calculation unit 130 and a thickness comparison unit 140. Furthermore, the PCB handling unit 110, the impedance measurement unit 120, the thickness calculation unit 130 and the thickness comparison unit 140 are connected to each other via an interface unit 150 such as a general purpose interface bus (GPIB), so that signals can be transmitted among the components.

The PCB handling unit 110 may take a PCB 12 out of an incoming cassette 10 and place the PCB 12 on a PCB holder (not shown), prior to measurement of a thickness of at least one insulating layer of the PCB 12. Then, after the measurement, the PCB handling unit 110 may move the PCB 12 into one of the outgoing cassettes 20 and 30 depending on the results of the measurement. For this purpose, the PCB handling unit 110 may include components capable of holding the PCB 12 while it is measured. When the PCB handling unit 110 locates the PCB 12 on the PCB holder and therefore preparation for the measurement of the thickness of at least one insulating layer of the PCB 12 is completed, a signal indicative of the completion of the preparation may be transmitted to the impedance measurement unit 120 via the interface unit 150.

The impedance measurement unit 120 may input a plurality of input signals to a transmission line of the PCB 12, the transmission line being located on the insulating layer. Further, the impedance measurement unit 120 may receive output signals in response to the input signals, which are transmitted from the transmission line. Furthermore, the impedance measurement unit 120 may determine impedance values of the insulating layer based on the input signals and the output signals. Here, each of the signals may have a respective (or different) frequency.

In determining the impedance values, the impedance measurement unit 120 may calculate S-parameter values of the insulating layer by comparing magnitudes and phases of the input signals and those of the output signals. Then, the impedance measurement unit 120 may convert the S-parameter values into respective impedance values by using reflection coefficients such as S11 and S22 of S-parameters. Further, a Smith chart may be utilized to convert the S-parameter values. Furthermore, the impedance measurement unit 120 may plot the converted impedance values on a Smith chart so that a tester can be visually notified of the impedance values. After the impedance measurement unit 120 has determined all desired impedance values for the PCB 12, the impedance measurement unit 120 may send a signal indicative of the completion to the thickness calculation unit 130 via the interface unit 150.

The impedance measurement unit 120 may include a Radio Frequency (RF) probe 122 that inputs the input signals to the transmission line of the PCB and receives the output signals. In some examples, the impedance measurement unit 120 may align the RF probe 122 so that the RF probe 122 can be placed in a predetermined test region (for example, ends of the transmission line) of the PCB 12. For example, the impedance measurement unit 120 may capture an image of the test coupon of the PCB 12 using a camera device installed in the impedance measurement unit 120, indentify a test region by processing the captured image, and move the RF probe 122 to the identified test region. Alternatively, in order to place the RF probe 122 in the predetermined test region of the test coupon of the PCB 12, the PCB 12 can be relocated by the PCB handling unit 110. For example, the PCB handling unit 110 may rotate the PCB 12 or move the PCB 12 in a lateral or vertical direction so that the test region can be located immediately below the RF probe 122. Furthermore, when multiple PCBs are to be measured, information on the arrangement of the RF probe 122 or PCB may be stored in memory for a first PCB, and then the information may be used for second and subsequent PCBs in a same manner.

The thickness calculation unit 130 may calculate the thickness of at least one insulating layer of the PCB based on the impedance values determined by the impedance measurement unit 120. For example, the thickness calculation unit 130 may select an impedance value having the smallest imaginary part among the impedance values, and then may calculate a thickness based on the selected impedance value. Equations representative of the relationship between the selected impedance value and the thickness will be subsequently described. After the thickness of the at least one insulating layer of the PCB has been calculated by the thickness calculation unit 130, the thickness calculation unit 130 may send a signal indicative of the completion to the thickness comparison unit 140 together with data of the calculated thickness, via the interface unit 150.

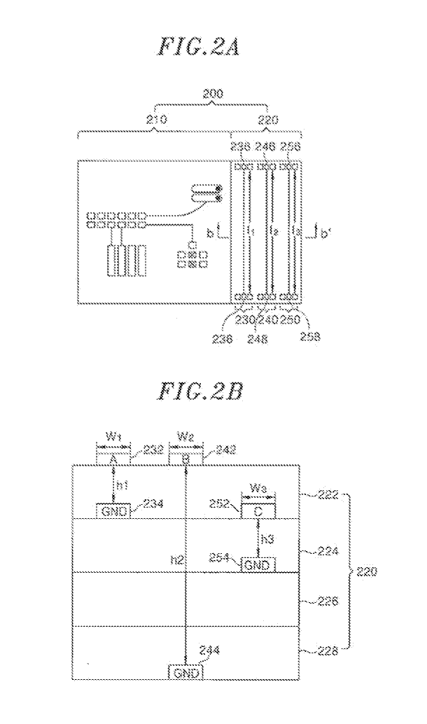

The thickness comparison unit 140 may determine whether the calculated thickness falls within a predetermined range. Based on the result of the comparison, the thickness comparison unit 140 may determine whether the PCB meets desired quality requirements. For example, it may be determined that the PCB meets the desired quality requirements if the calculated thickness falls within a predetermined numerical range, while it may be determined that the PCB is defective if the calculated thickness does not fall within the predetermined numerical range. Then, the thickness comparison unit 140 may send a signal indicative of the results of the determination to the PCB handling unit 110 via the interface unit 150. Then the PCB handling unit 110 may place the corresponding PCB into one of the outgoing cassettes 20 and 30 based on the signal. The way in which the apparatus 100 measures the thicknesses of one or more desired layers of a PCB will be described in greater detail with reference to FIGS. 2 to 5.

FIGS. 2A and 2B respectively are schematic and cross-sectional views illustrating a PCB having a test region, according to a representative embodiment. In greater detail, FIG. 2A is a plan view of PCB 200, and FIG. 2B is a cross-sectional view of a test region 220 taken along line b-b′ of FIG. 2A.

As shown in FIG. 2A, the PCB 200 may be divided into two regions, a product region 210 and a test region 220. The product region 210 is used for accommodating electronic components, and the test region 220 is reserved for testing the PCB 200, which includes at least one test coupon thereon. A transmission line and a ground line are located on both of the regions 210 and 220. Further, the test region 220 includes exactly the same layers as the product region 210. That is, the test region 220 of the PCB 200 is manufactured to have substantially the same number of layers of the same thickness as the product region 210 of the PCB 200.

For PCB 200, measuring a thickness of an insulating layer is performed on at least one of the test coupons in the test region 220 of the PCB 200. In some examples, the number of necessary test coupons may be determined depending on the number and locations of insulating layers to be measured. For example, as shown in FIG. 2A, three test coupons 230, 240 and 250 may be provided.

Each of the test coupons 230, 240 and 250 of the test region 220 includes a respective transmission line 232, 242 or 252 and a respective ground line 234, 244 or 254. Each of the transmission lines 232, 242 and 252 is disposed on a respective insulating layer to be measured, while each of the ground lines 234, 244 and 254 is disposed in a respective lower portion of the insulating layer. For example, when the thicknesses of a total of three combinations of insulating layers (e.g. a thickness of a first (top) layer 222 of the PCB 200, a thickness of first to fourth layers 222 to 228 and a thickness of a second layer 224) are desired to be measured, a total of three test coupons 230, 240 and 250 may be prepared, as shown in FIG. 2B. In this case, the test coupon 230 may include the transmission line 232 located on the first layer 222 and the ground line 234 located in the lower end portion of the first layer 222, the test coupon 240 may include the transmission line 242 located on the first layer 222 and the ground line 244 located in the lower end portion of the fourth layer 228, and the test coupon 250 may include the transmission line 252 located on the second layer 224 and the ground line 254 located in the lower end of the second layer 224. Here, in order to avoid interference between the signals of the test coupons 230, 240 and 250 transmitted therethrough, further ground lines may be disposed on the right and left sides of the transmission lines 232, 242 and 252 and the ground lines 234, 244 and 254.

The width and length of each of the transmission and ground lines may be determined depending on the design specifications for the test coupons, requirements, circumstances or the like. For example, the lengths 11, 12 and 13 may be all 14.4 mm, the width W1 of the transmission line 232 of the test coupon 230 may be 150 nm, and the width W2 of the transmission line 242 of the test coupon 240 may be 130 nm, and the width W3 of the transmission line 252 of the test coupon 250 may be 100 nm. However, the transmission and ground lines may have other widths and lengths then as specifically described.

The RF probe 122 of the impedance measurement unit 120 may input a plurality of input signals via first side ends 236, 246 and 256 of the transmission lines 232, 242 and 252 of the test coupons 230, 240 and 250, and receive the output signals, transmitted via the transmission lines 232, 242 and 252, via the opposite side ends 238, 248 and 258 of the transmission lines 232, 242 and 252. In some examples, the RF probe 122 may further input a plurality input signals via the opposite side ends 238, 248 and 258 and receive the output signals via the first side ends 236, 246 and 256. Then, the impedance measurement unit 120 may determine impedance values of each of the insulating layers based on the input signals and output signals. Specifically, the impedance measurement unit 120 may calculate S-parameter values of each of the insulating layers based on the input signals inputted via the first side ends 236, 246 and 256 and the opposite side ends 238, 248 and 258, and the output signals outputted via the first side ends 236, 246 and 256 and the opposite side ends 238, 248 and 258. For example, the impedance measurement unit 120 may calculate S-parameter values of the first layer 222 by comparing magnitudes and phases of input signals inputted via side ends 236 and 238, and output signals outputted via side ends 238 and 236, respectively.

Each of the input signals has a respective frequency. Here, the respective frequency of the input signals may be selected from a predetermined range in consideration of the material, usage and structure of the PCB 200. For example, the respective frequency may be in the range of 1 to 4 GHz. Further, the number of the input signals may be selected in consideration of the resolution and measurement time. For example, the number of the signals may be in the range of 5 to 20.

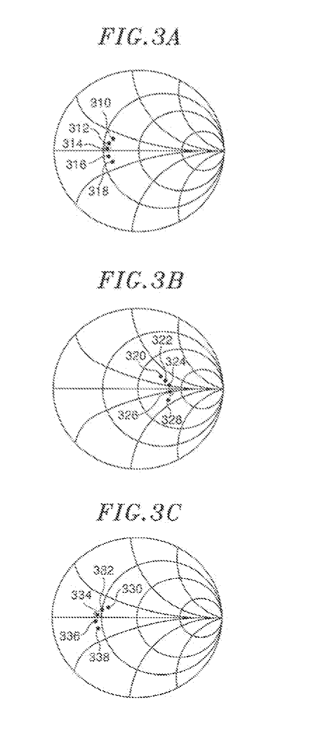

FIGS. 3A to 3C illustrate Smith charts representing exemplary results of impedance values for at least one insulating layer, according to a representative embodiment. In greater detail, FIG. 3A to 3C are Smith charts showing exemplary impedance values determined for the test coupons 230, 240 and 250, respectively.

For example, the impedance measurement unit 120 may use five different signals as input signals to each of the test coupons 230, 240 and 250. Then, the impedance measurement unit 120 may calculate five S-parameter values for each of the test coupons 230, 240 and 250. The acquired S-parameter values may be converted into respective impedance values by the impedance measurement unit 120. Further, the converted impedance values may be plotted on Smith charts, as shown in FIGS. 3A to 3C.

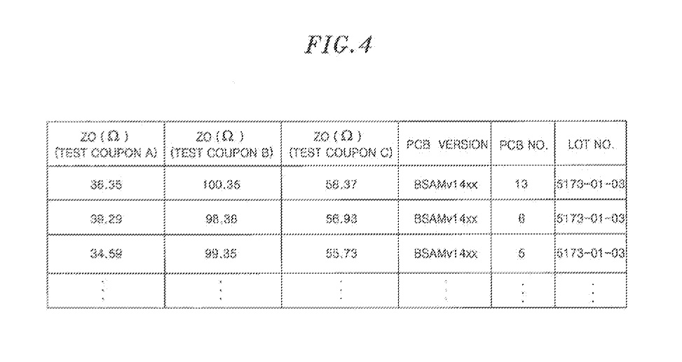

Furthermore, the impedance measurement unit 120 selects an impedance value having a smallest imaginary part among the impedance values. For example, referring to FIGS. 3A to 3B, an impedance value 314 having the smallest imaginary part is selected from among impedance values 310, 312, 314, 316 and 318 obtained for the test coupon 230 as shown in FIG. 3A, an impedance value 326 is selected from among the impedance values 320, 322, 324, 326 and 328 obtained for the test coupon 240 as shown in FIG. 3B, and an impedance value 334 is selected from among impedance values 330, 332, 334, 336 and 338 acquired for the test coupon 250 as shown in FIG. 3C. The impedance values 314, 326 and 334 selected as described above may be listed along with information about the insulating PCB, as shown in FIG. 4.

FIG. 4 illustrates exemplary results of impedance values for at least one insulating layer, according to a representative embodiment. Referring to FIG. 4, the impedance value measured and selected for each of the test coupons by the impedance measurement unit 120 is listed in a table, along with the information about the insulating PCB such as the PCB version, PCB number and LOT number of the PCB. These impedance values and PCB information may be sent to the thickness calculation unit 130 via the interface unit 150.

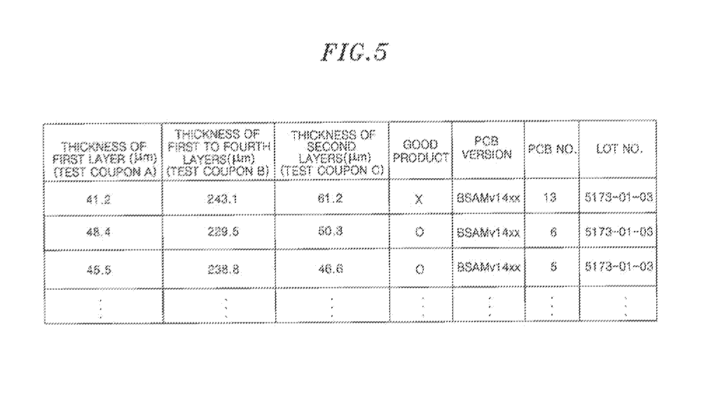

FIG. 5 illustrates exemplary results of thicknesses for at least one insulating layer, according to a representative embodiment. After the thickness calculation unit 130 receives the impedance values, shown in FIG. 4, from the impedance measurement unit 120, the thickness calculation unit 130 may calculate the thickness based on the impedance values. Equations for calculating the thicknesses of the insulating layers based on the impedance values can be derived as described below.

First, with regard to the transmission lines of each of the test coupons, an impedance value may be expressed using the width W of a transmission line, the distance between the transmission line and the corresponding ground line, that is, the thickness h of a related layer to be measured, and a dielectric constant Fr of the related layer as parameters, as follows:

$$\begin{matrix}\begin{matrix}{Z}_{0} = \frac{60}{\sqrt{{ɛ}_{r}}} ln ( \frac{8 h}{W} + \frac{W}{4 h} ) ( if W \text{/} h \leq 1 ) \\ = \frac{120 π}{\sqrt{{ɛ}_{r}} [ \begin{matrix}W \text{/} h + 1.393 + 0.667 \\ ln ( W \text{/} h + 1.444 )\end{matrix} ]} ( if W \text{/} h \geq 1 )\end{matrix} & ( 1 ) \\ \begin{matrix}\frac{W}{h} = \frac{8 {e}^{A}}{{e}^{2 A} - 2} ( if W \text{/} h < 2 ) \\ = \frac{2}{π} [ \begin{matrix}B - 1 - ln ( 2 B - 1 ) + \frac{{ɛ}_{r} - 1}{2 {ɛ}_{r}} \\ \{ ln ( B - 1 ) + 0.39 - \frac{0.61}{{ɛ}_{r}} \}\end{matrix} ] ( if W \text{/} h > 2 )\end{matrix} & ( 2 ) \\ A = \frac{{Z}_{0}}{60} \sqrt{\frac{{ɛ}_{r} + 1}{2}} + \frac{{ɛ}_{r} - 1}{{ɛ}_{r} + 1} ( 0.23 + \frac{0.11}{{ɛ}_{r}} ) \\ B = \frac{377 π}{2 {Z}_{0} \sqrt{{ɛ}_{r}}} & \end{matrix}$$

Rearranging Equation 2 for the thickness h of the layer to be measured, the following equations can be obtained.

$$\begin{matrix}h = \frac{W ( {e}^{2 A} - 2 )}{8 {e}^{A}} ( if W \text{/} h < 2 ) \\ = \frac{π W}{2 [ \begin{matrix}B - 1 - In ( 2 B - 1 ) + \frac{{ɛ}_{r} - 1}{2 {ɛ}_{r}} \\ \{ In ( B - 1 ) + 0.39 - \frac{0.61}{{ɛ}_{r}} \}\end{matrix} ]} ( if W \text{/} h > 2 )\end{matrix} \\ A = \frac{{Z}_{0}}{60} \sqrt{\frac{{ɛ}_{r} + 1}{2}} + \frac{{ɛ}_{r} - 1}{{ɛ}_{r} + 1} ( 0.23 + \frac{0.11}{{ɛ}_{r}} ) \\ B = \frac{377 π}{2 {Z}_{0} \sqrt{{ɛ}_{r}}} \qquad ( 3 )$$

The thicknesses of all the layers to be measured may be obtained by calculating a thickness based on an impedance value selected for each test coupon using the thickness calculation unit 130. Furthermore, the thickness comparison unit 140 may determine whether the calculated thicknesses of insulating layers fall within a predetermined numerical range. For example, when the thicknesses of the first and second layers 222 and 224 fall within a range from 40 μm to 60 μm, and the thickness of the first layer 222 to the fourth layer 228 falls within a range from 220 μm to 270 μm, the PCB may be determined to meet the desired quality requirements. From FIG. 5, it can be seen that PCB No. 13 is determined as defective.

The thickness value and PCB information of a PCB may be sent to the PCB handling unit 110 via the interface unit 150 or may be stored in a separated memory.

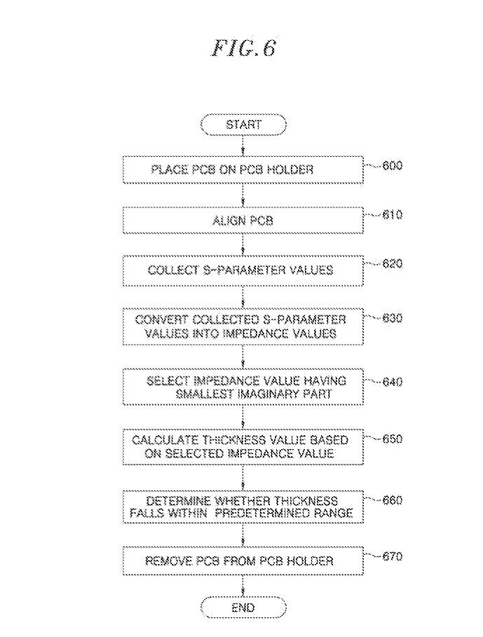

FIG. 6 illustrates a flow diagram of a process for measuring a thickness of at least one insulating layer of a PCB, according to another representative embodiment. The method of FIG. 6 may be implemented using the apparatus 100 including the PCB handling unit 110, the impedance measurement unit 120 having the RF probe 122, the thickness calculation unit 130, the thickness comparison unit 140, and the interface unit 150. An exemplary process may include one or more operations, actions, or functions as illustrated by one or more steps S600, S610, S620, S630, S640, S650, S660 and/or S670. Although illustrated as discrete blocks, various blocks may be divided into additional blocks, combined into fewer blocks, or eliminated, depending on the desired implementation. Processing may begin at step S600.

At step S600 shown in FIG. 6, the PCB handling unit 110 may place a PCB on a PCB holder. For example, in order to measure the thickness of at least one insulating layer of the PCB, the PCB handling unit 110 may take the PCB out of the incoming cassette 10, and place the PCB on the PCB holder.

Thereafter, the PCB may be aligned at step S610. For example, the PCB handling unit 110 may align the PCB such that the RF probe 122 is located on the transmission line located on the insulating layer of the PCB by rotating the PCB or moving the PCB in a lateral or vertical direction.

Thereafter, S-parameter values may be collected at step S620. For example, the impedance measurement unit 120 may input a plurality of input signals into the transmission line, receive output signals from the transmission line, and determine S-parameter values for the insulating layer based on the input signals and the output signals.

Thereafter, the collected S-parameter values may be converted into respective impedance values at step S630. For example, the impedance measurement unit 120 may convert the S-parameter values, collected for the insulating layer, into impedance values by using a Smith chart.

Thereafter, an impedance value having a smallest imaginary part may be selected at step S640. For example, the impedance measurement unit 120 may select an impedance value having a smallest imaginary part among the impedance values.

Thereafter, a thickness value may be calculated based on the selected impedance value at step S650. For example, the thickness calculation unit 130 may calculate a thickness value h based on the impedance value Z₀, and a dielectric constant ∈ᵣ of the insulating layer, using the following equation:

$$\begin{matrix}h = \frac{W ( {e}^{2 A} - 2 )}{8 {e}^{A}} ( if W \text{/} h < 2 ) \\ = \frac{π W}{2 [ \begin{matrix}B - 1 - In ( 2 B - 1 ) + \frac{{ɛ}_{r} - 1}{2 {ɛ}_{r}} \\ \{ In ( B - 1 ) + 0.39 - \frac{0.61}{{ɛ}_{r}} \}\end{matrix} ]} ( if W \text{/} h > 2 )\end{matrix} \\ A = \frac{{Z}_{0}}{60} \sqrt{\frac{{ɛ}_{r} + 1}{2}} + \frac{{ɛ}_{r} - 1}{{ɛ}_{r} + 1} ( 0.23 + \frac{0.11}{{ɛ}_{r}} ) \\ B = \frac{377 π}{2 {Z}_{0} \sqrt{{ɛ}_{r}}} \qquad ( 4 )$$

Thereafter, it may be determined whether a calculated thickness falls within a predetermined range at step S660. At step S660, the thickness comparison unit 140 may determine whether the thickness calculated by the thickness calculation unit 130 falls within a predetermined range.

Thereafter, the PCB may be removed from the PCB holder at step S670. For example, the PCB handling unit 110 may remove the corresponding PCB from the PCB holder.

Using the above-described method, the thickness of said at least one insulating layer of a PCB can be accurately and rapidly measured without damaging the PCB, regardless of the structure of the PCB. Furthermore, although the method of measuring the thickness of at least one insulating layer of a single PCB has been described, it will be apparent that the thicknesses of the insulating layers of multiple PCBs can be automatically and rapidly measured by repeating the above-described process.

While various representative embodiments have been shown and described, it will be understood by those skilled in the art that various changes and modifications may be made without departing from the spirit and scope of the invention as defined in the following claims.

What is claimed is:

1. An apparatus for measuring a thickness of at least one insulating layer of a printed circuit board (PCB), the at least one insulating layer having a transmission line located thereon, the apparatus comprising:
an impedance measurement unit configured to input a plurality of input signals to the transmission line, to receive output signals from the transmission line, and to determine impedance values of said at least one insulating layer based on the input signals and the output signals, wherein each of the input signals has a respective frequency; and
a thickness calculation unit configured to calculate a thickness of the at least one insulating layer based on the impedance values.

2. The apparatus of claim 1, wherein the impedance measurement unit is configured to calculate S-parameter values of the at least one insulating layer based on the input signals and the output signals, and to convert the calculated S-parameter values into respective impedance values.

3. The apparatus of claim 1, wherein the thickness calculation unit is configured to select from among the impedance values an impedance value having a smallest imaginary part, and to calculate the thickness of the at least one insulating layer based on the selected impedance value.

4. The apparatus of claim 3, wherein the thickness calculation unit is configured to calculate the thickness in accordance with the following equation:
$$\begin{matrix}h = \frac{W ( {e}^{2 A} - 2 )}{8 {e}^{A}} ( if W \text{/} h < 2 ) \\ = \frac{π W}{2 [ \begin{matrix}B - 1 - In ( 2 B - 1 ) + \frac{{ɛ}_{r} - 1}{2 {ɛ}_{r}} \\ \{ In ( B - 1 ) + 0.39 - \frac{0.61}{{ɛ}_{r}} \}\end{matrix} ]} ( if W \text{/} h > 2 )\end{matrix}$$
$$A = \frac{{Z}_{0}}{60} \sqrt{\frac{{ɛ}_{r} + 1}{2}} + \frac{{ɛ}_{r} - 1}{{ɛ}_{r} + 1} ( 0.23 + \frac{0.11}{{ɛ}_{r}} )$$
$$B = \frac{377 π}{2 {Z}_{0} \sqrt{{ɛ}_{r}}}$$
where h is the thickness, W is a width of the transmission line, Z₀ is the selected impedance value, and F, is a dielectric constant of said at least one insulating layer.

5. The apparatus of claim 1, wherein the apparatus further comprises a thickness comparison unit configured to determine whether the thickness falls within a predetermined range.

6. The apparatus of claim 1, wherein the impedance measurement unit includes a radio frequency (RF) probe for inputting the input signals to one end of the transmission line and receiving the output signals from the other end of the transmission line.

7. The apparatus of claim 6, further comprising a handling unit configured to align the transmission line with the RF probe such that the RF probe is located on the transmission line.

8. The apparatus of claim 1, wherein the at least one insulating layer includes a ground line embedded in a lower portion thereof.

9. A method of measuring a thickness of at least one insulating layer of a printed circuit board (PCB), the at least one insulating layer having a transmission line located thereon, the method comprising:
measuring impedance values by inputting a plurality of input signals to the transmission line, by receiving output signals from the transmission line, and by determining impedance values based on the input signals and the output signals, wherein each of the input signals has a respective frequency; and
calculating a thickness of the at least one insulating layer based on the measured impedance values.

10. The method of claim 9, wherein said measuring comprises:
calculating S-parameter values of the at least one insulating layer based on the input signals and the output signals; and
converting the calculated S-parameter values into respective impedance values.

11. The method of claim 9, wherein said calculating comprises:
selecting from among the impedance values an impedance value having a smallest imaginary part; and
calculating the thickness in accordance with the following equation:
$$\begin{matrix}h = \frac{W ( {e}^{2 A} - 2 )}{8 {e}^{A}} ( if W \text{/} h < 2 ) \\ = \frac{π W}{2 [ \begin{matrix}B - 1 - In ( 2 B - 1 ) + \frac{{ɛ}_{r} - 1}{2 {ɛ}_{r}} \\ \{ In ( B - 1 ) + 0.39 - \frac{0.61}{{ɛ}_{r}} \}\end{matrix} ]} ( if W \text{/} h > 2 )\end{matrix}$$
$$A = \frac{{Z}_{0}}{60} \sqrt{\frac{{ɛ}_{r} + 1}{2}} + \frac{{ɛ}_{r} - 1}{{ɛ}_{r} + 1} ( 0.23 + \frac{0.11}{{ɛ}_{r}} )$$
$$B = \frac{377 π}{2 {Z}_{0} \sqrt{{ɛ}_{r}}}$$
where h is the thickness, W is a width of the transmission line, Z₀ is the selected impedance value, and ∈ᵣ is a dielectric constant of the at least one insulating layer.

12. The method of claim 9, further comprising determining whether the thickness falls within a predetermined range.
